(19) United States
(12) Patent Application Publication
(10) Pub. No.: US 2026/0329629 A1
(43) Pub. Date: Oct. 22, 2026

(54) HANDLING RUNTIME BOTTLENECKS BY ADJUSTING NUMBER OF THREADS FOR EACH THREAD TYPE

(71) Applicant: International Business Machines Corporation, Armonk, NY (US)

(72) Inventors: Hui Wang, Beijing (CN); Yu Mei Dai, Beijing (CN); Peng Hui Jiang, Beijing (CN); Mai Zeng, Beijing (CN); Xiao Chen Huang, Beijing (CN); Wei Li, Beijing (CN); Xiang Yu Xue, Rizhao (CN)

(21) Appl. No.: 19/181,497

(22) Filed: Apr. 17, 2025

(51) Int. Cl. G06F 9/48; G06F 11/30

(52) U.S. Cl. CPC G06F 9/4881; G06F 11/3058

(57) ABSTRACT

A computer-implemented method, system, and computer program product for handling runtime bottlenecks. A model is trained to determine a direction to tune threads for each thread type for each component of a complex computing system based on environmental conditions (e.g., memory usage, processor (CPU) usage, thread busy rate, etc.). Furthermore, current environmental conditions of the complex computing system are monitored. The number of threads for each thread type for a component of the complex computing system is then adjusted based on the direction to tune the threads for each thread type for the component in the system provided by the model, which is based on the current environmental conditions of the system. In this manner, runtime bottlenecks are effectively handled in situations involving threads using thread adjustments. Based on such thread adjustments, runtime bottlenecks are prevented from actually occurring by dynamically adjusting the number of threads to the available resources.

### TECHNICAL FIELD

The present disclosure relates generally to complex computing systems, and more particularly to handling runtime bottlenecks by adjusting the number of threads for each thread type for each component of the complex computing system.

### BACKGROUND

In complex computing systems (e.g., z/OS online transaction system), multiple components and functions collaborate to provide services to users. These components may include different software modules and services. In such a system, such components both collaborate (work together) as well as compete for limited resources (e.g., processing power, memory) leading to an uneven distribution of those resources and creating runtime bottlenecks. A runtime bottleneck is a point within the computer program or system where a single component or process is unable to keep up with the demands placed on it thereby restricting the system's capacity to function efficiently.

For example, in an active-active system, in order to keep data consistent (i.e., ensure that all copies of data across multiple servers remain identical and up-to-date), it is necessary to copy and compare data. An active-active system refers to a system architecture where multiple nodes or servers are simultaneously operational and actively processing requests. That is, in such a system, all nodes are actively contributing to the workload and can seamlessly take over if one fails thereby providing high availability and redundancy by distributing the load across all active components.

In the active-active system, the component that is utilized to keep data consistent is the data consistency comparison component. Such a component includes three different types of threads, namely, the tPartioner thread type (partitions large data tables), the tCombiner thread type (performs data comparison) and the DiffReporter thread type (performs differential reporting). A thread is a single sequence of instructions within a program that can be executed independently allowing multiple tasks (task is a unit of work that needs to be completed) to seemingly run simultaneously within the same process effectively creating a form of multitasking within an application.

Since each of these thread types are multithreaded (i.e., each type of thread is capable of running multiple threads within itself allowing for concurrent execution of different parts of a task simultaneously), it is possible that one of the threads will become the bottleneck in the compare process performed by the data consistency comparison component. That is, even though the system is using multiple threads to run tasks concurrently, there is a chance that one particular thread within the system could become the slowest part and hold up the entire process due to excessive workload or inefficient code within that specific thread thereby creating a bottleneck.

Unfortunately, there is not currently a means for effectively handling runtime bottlenecks, including in situations involving threads.

### SUMMARY

In one embodiment of the present disclosure, a computer-implemented method for handling runtime bottlenecks comprises training a model to determine a direction to tune threads for each thread type for each component of a system based on environmental conditions. The method further comprises monitoring current environmental conditions of the system. The method additionally comprises adjusting a number of threads for each thread type for a component in the system based on a direction to tune the threads for each thread type for the component in the system provided by the model based on the current environmental conditions of the system.

Furthermore, in one embodiment of the present disclosure, the method additionally comprises analyzing priority and usage of each thread in each component in the system.

Additionally, in one embodiment of the present disclosure, the method further comprises assigning thread generation and thread usage restrictions for each component in the system based on the current environmental conditions and the priority and usage of each thread in each component of the system.

Furthermore, in one embodiment of the present disclosure, the method additionally comprises designing a reward function in a reinforcement learning environment where an agent receives a positive reward when different components of the system utilize threads efficiently based on thread scheduling and a negative reward when thread usage is imbalanced or inefficient based on the thread scheduling.

Additionally, in one embodiment of the present disclosure, the method further comprises formulating a thread scheduling strategy for the model based on the positive rewards and the negative rewards.

Furthermore, in one embodiment of the present disclosure, the method additionally comprises calculating a reward based on the current environmental conditions of the system and the adjustment of the number of threads for each thread type for the component of the system.

Additionally, in one embodiment of the present disclosure, the method further comprises monitoring the current environmental conditions of the system after adjusting the number of threads for each thread type for the component in the system a first time. The method additionally comprises adjusting the number of threads for each thread type for the component in the system a second time based on a direction to tune the threads for each thread type for the component in the system provided by the model a second time based on the current environmental conditions of the system monitored after adjusting the number of threads for each thread type for the component in the system the first time.

Other forms of the embodiment of the computer-implemented method described above are in a system and in a computer program product.

Accordingly, embodiments of the present disclosure effectively handle runtime bottlenecks.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components used by the runtime bottleneck handler for effectively handling runtime bottlenecks in accordance with an embodiment of the present disclosure;

FIG. 3 illustrates fine-tuning the thread scheduling strategy in accordance with an embodiment of the present disclosure;

FIG. 4 illustrates an embodiment of the present disclosure of the hardware configuration of the runtime bottleneck handler which is representative of a hardware environment for practicing the present disclosure;

FIG. 5 is a flowchart of a method for handling runtime bottlenecks in accordance with an embodiment of the present disclosure;

FIG. 6 is a flowchart of a method for formulating a thread scheduling strategy in accordance with an embodiment of the present disclosure; and

FIG. 7 is a flowchart of a method for fine-tuning the thread scheduling strategy in accordance with an embodiment of the present disclosure.

### DETAILED DESCRIPTION

In one embodiment of the present disclosure, a computer-implemented method for handling runtime bottlenecks comprises training a model to determine a direction to tune threads for each thread type for each component of a system based on environmental conditions. The method further comprises monitoring current environmental conditions of the system. The method additionally comprises adjusting a number of threads for each thread type for a component in the system based on a direction to tune the threads for each thread type for the component in the system provided by the model based on the current environmental conditions of the system.

In this manner, runtime bottlenecks are effectively handled.

Furthermore, in one embodiment of the present disclosure, the method additionally comprises analyzing priority and usage of each thread in each component in the system.

In this manner, data can be interpreted to identify potential bottlenecks and optimize thread scheduling.

Additionally, in one embodiment of the present disclosure, the method further comprises assigning thread generation and thread usage restrictions for each component in the system based on the current environmental conditions and the priority and usage of each thread in each component of the system.

In this manner, resource utilization is optimized based on real-time needs.

Furthermore, in one embodiment of the present disclosure, the method additionally comprises designing a reward function in a reinforcement learning environment where an agent receives a positive reward when different components of the system utilize threads efficiently based on thread scheduling and a negative reward when thread usage is imbalanced or inefficient based on the thread scheduling.

In this manner, a reinforcement learning agent is incentivized to utilize threads effectively by rewarding actions that optimize thread utilization within the constraints (e.g., thread generation and usage restrictions) and penalizing excessive thread creation or unnecessary thread usage that violates the restrictions.

Additionally, in one embodiment of the present disclosure, the method further comprises formulating a thread scheduling strategy for the model based on the positive rewards and the negative rewards.

In this manner, the thread scheduling strategy determines which threads gets to use the CPU at any give time based on factors, such as priority levels, and the current state (e.g., running, waiting, etc.) of each thread.

Furthermore, in one embodiment of the present disclosure, the method additionally comprises calculating a reward based on the current environmental conditions of the system and the adjustment of the number of threads for each thread type for the component of the system.

In this manner, a model is trained in a reinforcement learning environment to predict a direction to tune the threads for each thread type for a component of a system (e.g., complex computing system).

Additionally, in one embodiment of the present disclosure, the method further comprises monitoring the current environmental conditions of the system after adjusting the number of threads for each thread type for the component in the system a first time. The method additionally comprises adjusting the number of threads for each thread type for the component in the system a second time based on a direction to tune the threads for each thread type for the component in the system provided by the model a second time based on the current environmental conditions of the system monitored after adjusting the number of threads for each thread type for the component in the system the first time.

In this manner, the number of threads for each thread type for a component of the system (e.g., complex computing system) is continuously adjusted based on the current environmental conditions (e.g., thread busy rate) so as to prevent a potential bottleneck from actually occurring.

Other forms of the embodiment of the computer-implemented method described above are in a system and in a computer program product.

As stated above, in complex computing systems (e.g., z/OS online transaction system), multiple components and functions collaborate to provide services to users. These components may include different software modules and services. In such a system, such components both collaborate (work together) as well as compete for limited resources (e.g., processing power, memory) leading to an uneven distribution of those resources and creating runtime bottlenecks. A runtime bottleneck is a point within the computer program or system where a single component or process is unable to keep up with the demands placed on it thereby restricting the system's capacity to function efficiently.

For example, in an active-active system, in order to keep data consistent (i.e., ensure that all copies of data across multiple servers remain identical and up-to-date), it is necessary to copy and compare data. An active-active system refers to a system architecture where multiple nodes or servers are simultaneously operational and actively processing requests. That is, in such a system, all nodes are actively contributing to the workload and can seamlessly take over if one fails thereby providing high availability and redundancy by distributing the load across all active components.

In the active-active system, the component that is utilized to keep data consistent is the data consistency comparison component. Such a component includes three different types of threads, namely, the tPartioner thread type (partitions large data tables), the tCombiner thread type (performs data comparison) and the DiffReporter thread type (performs differential reporting). A thread is a single sequence of instructions within a program that can be executed independently allowing multiple tasks (task is a unit of work that needs to be completed) to seemingly run simultaneously within the same process effectively creating a form of multitasking within an application.

Since each of these thread types are multithreaded (i.e., each type of thread is capable of running multiple threads within itself allowing for concurrent execution of different parts of a task simultaneously), it is possible that one of the threads will become the bottleneck in the compare process performed by the data consistency comparison component. That is, even though the system is using multiple threads to run tasks concurrently, there is a chance that one particular thread within the system could become the slowest part and hold up the entire process due to excessive workload or inefficient code within that specific thread thereby creating a bottleneck.

Unfortunately, there is not currently a means for effectively handling runtime bottlenecks, including in situations involving threads.

The embodiments of the present disclosure provide a means for effectively handling runtime bottlenecks by automatically adjusting the number of threads for each thread type for the components of the complex computing system. In one embodiment, a model is trained, such as via reinforcement learning, to determine a direction to tune the threads for each thread type for each component of the complex computing system based on environmental conditions, such as the percentage of time the threads are actively executing (“thread busy rate”). Based on the thread busy rate, a potential runtime bottleneck may be detected and addressed by tuning the threads thereby preventing a runtime bottleneck from actually occurring. In one embodiment, the model is trained by first formulating a thread scheduling strategy based on designing a reward function in a reinforcement learning environment, where an agent receives a positive reward when the component of the complex computing system utilizes threads efficiently based on thread scheduling and receives a negative reward when thread usage is imbalanced or inefficient based on thread scheduling. The thread scheduling strategy of the model is then fine-tuned in which training of the model includes adjusting the number of threads for each thread type of the component based on the model prediction, which predicts the direction to tune the threads for each thread type for a component of the complex computing system based on the current environmental conditions. Based on the environmental conditions and the adjustment to the number of threads for each thread type for the component (“component action”), a reward is calculated. The reinforcement learning model continues to be trained to predict the direction to tune the threads for each thread type for each component of the complex computing system until the average reward over a set of episodes does not increase over a user-designated threshold. After training the model to predict the direction to tune the number of threads for each thread type for each component of the complex computing system based on environmental conditions, including the thread busy rate, the number of threads for each thread type of a component in the complex computing system is appropriately adjusted based on the model prediction (predicted direction to tune the threads for each thread type for the component in the complex computing system), which is based on the current environmental conditions of the complex computing system. In this manner, runtime bottlenecks are effectively handled in situations involving threads. A further description of these and other features will be provided below.

In some embodiments of the present disclosure, the present disclosure comprises a computer-implemented method, system, and computer program product for handling runtime bottlenecks. In one embodiment, a model is trained to determine a direction to tune threads for each thread type for each component of a complex computing system based on environmental conditions. Environmental conditions, as used herein, refer to the conditions of the elements of the complex computing system that directly impact its performance, such as memory usage, processor (CPU) usage, the state of the database tables and columns, the availability of resources, thread busy rate, etc. Furthermore, current environmental conditions of the complex computing system are monitored. The number of threads for each thread type for a component of the complex computing system is then adjusted based on the direction to tune the threads for each thread type for the component in the system provided by the model, which is based on the current environmental conditions of the system. In this manner, runtime bottlenecks are effectively handled in situations involving threads using thread adjustments. Based on such thread adjustments, runtime bottlenecks are prevented from actually occurring by dynamically adjusting the number of threads to the available resources. For example, processing power may be maximized without overloading the CPU or memory. Furthermore, the complex computing system may maintain a smooth performance even when dealing with a fluctuating workload.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

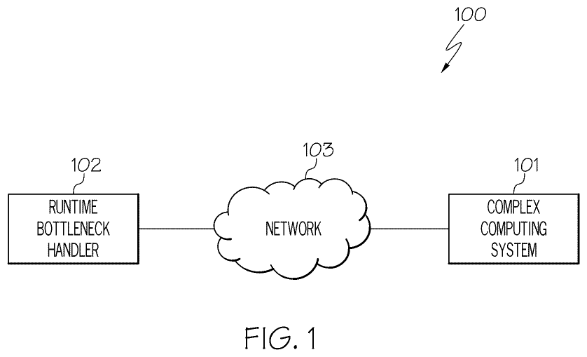

Referring now to the Figures in detail, FIG. 1 illustrates an embodiment of the present disclosure of a communication system 100 for practicing the principles of the present disclosure. Communication system 100 includes a complex computing system 101 connected to runtime bottleneck handler 102 via a network 103.

Complex computing system 101, as used herein, refers to a computing system that includes multiple components and functions that collaborate to provide services to users. An example of complex computing system 101 is the z/OS online transaction system. Another example of complex computing system 101 is the active-active system. The components of complex computing system 101, as used herein, include software modules and services. In complex computing system 101, such components both collaborate (work together) as well as compete for limited resources (e.g., processing power, memory) leading to an uneven distribution of those resources and creating bottlenecks. A bottleneck, as used herein, refers to a point in the system (e.g., complex computing system 101) where the flow of work is restricted due to a lack of resources.

In one embodiment, runtime bottleneck handler 102 is configured to effectively handle runtime bottlenecks in situations involving threads by automatically adjusting the number of threads for each thread type for the components of complex computing system 101.

As discussed further below, runtime bottleneck handler 102 trains a model, such as via reinforcement learning, to determine a direction to tune the threads for each thread type for each component of the complex computing system based on environmental conditions, such as the percentage of time the threads are actively executing (“thread busy rate”). A thread, as used herein, refers to a single sequence of instructions within a program that can be executed independently allowing multiple tasks (task is a unit of work that needs to be completed) to seemingly run simultaneously within the same process effectively creating a form of multitasking within an application. Based on the thread busy rate, a potential runtime bottleneck may be detected and addressed thereby preventing a runtime bottleneck from actually occurring.

In one embodiment, runtime bottleneck handler 102 trains the model by first formulating a thread scheduling strategy based on designing a reward function in a reinforcement learning environment, where an agent receives a positive reward when the component of the complex computing system utilizes threads efficiently based on thread scheduling and receives a negative reward when thread usage is imbalanced or inefficient based on thread scheduling. The thread scheduling strategy of the model is then fine-tuned by adjusting the number of threads for each thread type of the component based on the model prediction, which predicts the direction to tune the threads for each thread type for a component of the complex computing system based on the current environmental conditions. Based on the environmental conditions and the adjustment to the number of threads for each thread type of the component (“component action”), a reward is calculated. The reinforcement learning model continues to be trained to predict the direction to tune the threads for each thread type for each component of complex computing system 101 until the average reward over a set of episodes does not increase over a user-designated threshold.

In one embodiment, after training the model to predict the direction to tune the number of threads for each thread type for each component of complex computing system 101 based on environmental conditions, including the thread busy rate, runtime bottleneck handler 102 appropriately adjusts the number of threads for each thread type of a component in complex computing system 101 based on the model prediction (predicted direction to tune the threads for each thread type for the component in the complex computing system) based on the current environmental conditions of complex computing system 101. In this manner, runtime bottlenecks are effectively handled by adjusting the number of threads for each thread type for each component of a complex computing system based on the current environmental conditions, which may indicate the potential of a runtime bottleneck. Based on such thread adjustments, runtime bottlenecks are prevented from actually occurring by dynamically adjusting the number of threads to the available resources. For example, processing power may be maximized without overloading the CPU or memory. Furthermore, complex computing system 101 may maintain a smooth performance even when dealing with a fluctuating workload.

Furthermore, as discussed above, runtime bottleneck handler 102 is connected to complex computing system 101 via network 103. Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 902.11 standards network, various combinations thereof, etc. Other networks, whose descriptions are omitted here for brevity, may also be used in conjunction with system 100 of FIG. 1 without departing from the scope of the present disclosure.

A further discussion regarding these and other features is provided below.

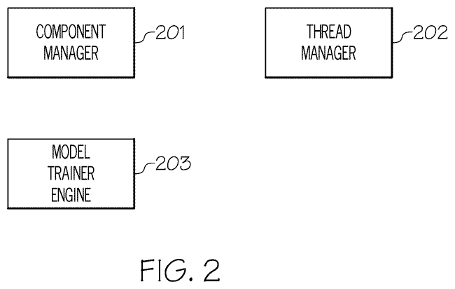

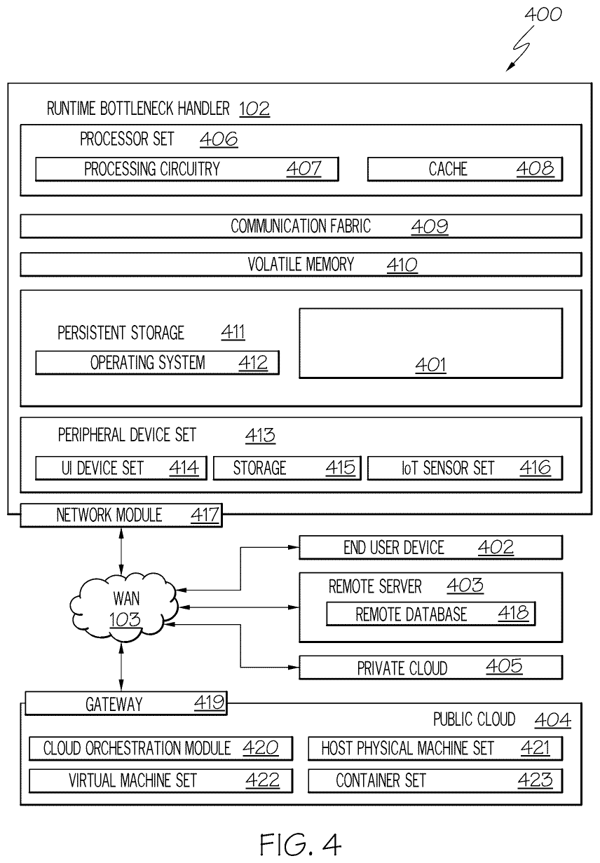

A description of the software components of runtime bottleneck handler 102 used for effectively handling runtime bottlenecks is provided below in connection with FIG. 2. A description of the hardware configuration of runtime bottleneck handler 102 is provided further below in connection with FIG. 4.

System 100 is not to be limited in scope to any one particular network architecture. System 100 may include any number of complex computing systems 101, runtime bottleneck handlers 102, and networks 103.

A discussion regarding the software components used by runtime bottleneck handler 102 for effectively handling runtime bottlenecks is provided below in connection with FIG. 2.

FIG. 2 is a diagram of the software components used by runtime bottleneck handler 102 for effectively handling runtime bottlenecks in accordance with an embodiment of the present disclosure.

Referring to FIG. 2, in conjunction with FIG. 1, runtime bottleneck handler 102 includes various components which are used in combination with training a model, such as via reinforcement learning, to determine a direction to tune threads for each thread type for each component of complex computing system 101 based on environmental conditions, such as the percentage of time the threads are actively executing (“thread busy rate”).

In connection with such training, a thread scheduling strategy is formulated, which determines, in part, the direction to tune threads for each thread type for each component of complex computing system 101 based on environmental conditions.

In one embodiment, the thread scheduling strategy is formulated using component manger 201, which analyzes the priority and usage of each thread in each component in complex computing system 101.

In one embodiment, component manager 201 analyzes the priority and usage of each thread within complex computing system 101 by utilizing a combination of system monitoring tools, profiling techniques, and application-specific logging to gather detailed information about thread execution times, processor usage, priority levels, and potential bottlenecks thereby enabling the identification of which threads are most activity utilized and if their assigned priorities align with their criticality within complex computing system 101.

In one embodiment, the system monitoring tools utilized by component manger 201 include operating system tools, such as the task manager, which includes detailed thread information, such as processor usage, priority levels, and the scheduling state. That is, such operating system tools provide a comprehensive view of running processes and their threads, including the processing usage and priority levels within the process hierarchy.

In one embodiment, the performance monitoring tools utilized by component manger 201 gather detailed performance metrics, such as cache misses, branch predictions, and context switches on a per-thread basis. Examples of such performance monitoring tools include perf and ptrace.

In one embodiment, the application-specific monitoring performed by component manager 201 includes logging, which captures the thread start/stop times, key events, and potential bottlenecks and correlating this information with system-level monitoring data. Furthermore, in one embodiment, component manager 201 utilizes application-specific metrics to track thread activity, such as queue lengths, wait times, and resource usage within the components.

In one embodiment, the profiling tools utilized by component manger 201 include sampling profiles (e.g., Profiler, gprof) that periodically sample the execution stack to identify which functions and threads are consuming the most processor time. Furthermore, in one embodiment, the profiling tools utilized by component manger 201 include instrumentation profilers, which insert code snippets in the application to measure specific function calls and thread activity.

In one embodiment, component manager 201 compares the assigned priority of threads with their processor usage to determine if high-priority threads are getting the adequate processor (CPU) time.

In one embodiment, component manager 201 analyzes the thread wait times. For example, component manager 201 investigates the threads that are frequently blocked on synchronization primitives or input/output operations, which could indicate potential concurrency issues.

In one embodiment, component manager 201 identifies which components are most impacted by thread contention or inefficiently scheduled based on performance data.

Runtime bottleneck handler 102 further includes thread manager 202 configured to monitor current environmental conditions, including the percentage of time the threads are actively executing (“thread busy rate”). Current environmental conditions, as used herein, refer to the conditions of the elements of complex computing system 101 that directly impact its performance at the present time, such as memory usage, processor (CPU) usage, the state of the database tables and columns, the availability of resources, thread busy rate, etc.

In one embodiment, thread manager 202 keeps track of the current performance of complex computing system 101 by specifically observing how much time its individual “threads” (small units of processing within a program) are actively working on tasks. An actively working thread, as used herein, refers to a thread that is performing work on the processor (CPU) and not waiting for input or paused.

In one embodiment, by thread manager 202 tracking the percentage of time threads are actively executing, thread manager 202 gauges how much processing power is being used by complex computing system 101 system at any given time.

Furthermore, in one embodiment, thread manager 202 performs performance analysis. For example, a high percentage of actively executing threads suggests that complex computing system 101 is under heavy load and may be experiencing performance issues. In another example, if specific applications or processes consistently have high thread activity, it could indicate that they are the primary cause of performance slowdown.

Additionally, in one embodiment, thread manager 202 monitors current environmental conditions, including thread activity, via a task manager, which allows thread manger 202 to obtain processor (CPU) usage and individual thread activity for each running process.

Furthermore, in one embodiment, thread manager 202 utilizes system monitoring tools to obtain detailed information about thread activity, including the percentage of time spent actively executing. Examples of such system monitoring tools include, but are not limited to, Datadog®, New Relic®, Dynatrace®, ManageEngine®, etc.

In one embodiment, thread manager 202 assigns thread generation and thread usage restrictions for each component in complex computing system 101 based on the priority and usage of each thread in each component in complex computing system 101 and the current environmental conditions.

That is, thread manager 202 determines how many threads each component of complex computing system 101 can create (thread generation) and how actively those threads should be used taking into account the priority of each thread within that component, how much each thread is currently being used, and the overall system conditions, such as memory usage, processor (CPU) usage, current thread activity (thread busy rate), etc.

Different threads within a component may have different levels of importance. As a result, in one embodiment, thread manager 202 prioritizes creating and utilizing higher priority threads prior to lower priority threads.

In one embodiment, thread usage restrictions involves setting limits on the number of threads a component can create at once, or throttling how often a particular thread is allowed to run, to prevent excessive resource consumption.

Thread manager 202 utilizes various software tools for assigning thread generation and thread usage restrictions for each component in complex computing system 101 including, but not limited to, Pthreads, FixedThreadPool, CachedThreadPool, ScheduledThreadPoolExecutor, etc.

Runtime bottleneck handler 102 additionally includes model trainer engine 203 configured to train a model, such as via reinforcement learning, to determine a direction to tune threads for each thread type for each component of complex computing system 101 based on environmental conditions, such as the thread busy rate.

In one embodiment, in connection with training the model to determine a direction to tune threads for each thread type for each component of complex computing system 101, model trainer engine 203 designs a reward function in a reinforcement learning environment where an agent receives a positive reward when different components of complex computing system 101 utilize threads efficiently based on thread scheduling and a negative reward when thread usage is imbalanced or inefficient based on thread scheduling. Thread scheduling, as used herein, refers to determining which thread should execute next thereby managing the order of execution among multiple threads where different thread types may have varying priorities depending on their function or importance within complex computing system 101.

In one embodiment, model trainer engine 203 incentivizes a reinforcement learning agent to utilize threads effectively by rewarding actions that optimize thread utilization within the constraints (e.g., thread generation and usage restrictions) and penalizing excessive thread creation or unnecessary thread usage that violates the restrictions.

In one embodiment, the elements of the reward function include the thread utilization metric, constraint violation penalty and positive/negative reinforcement.

In one embodiment, the thread utilization metric includes the thread wait time in which the reinforcement learning agent is penalized for creating threads that spend a significant time waiting for resources. In one embodiment, the thread utilization metric includes active thread count, where the reinforcement learning agent is rewarded for maintaining a balance number of active threads and maximizing utilization within the allowed thread limit.

In one embodiment, the constraint violation penalty includes applying a negative reward if the reinforcement learning agent creates more threads than the allowed limit. Furthermore, the constraint violation penalty includes applying a negative reward for excessive processor (CPU) or memory usage related to thread creation and management.

In one embodiment, model trainer engine 203 implements positive reinforcement, such as an incremental reward for efficient thread usage, a larger reward for optimal thread utilization, etc. For example, model trainer engine 203 awards small positive rewards for each decision that effectively utilizes threads within the constraints (e.g., creating a thread only when needed, recycling threads from a pool, etc.). In another example, model trainer engine 203 provides a larger reward when the reinforcement learning agent achieves near-optimal thread utilization while respecting limits.

In one embodiment, model trainer engine 203 implements negative reinforcement, such as a penalty for unnecessary thread creation, a penalty for exceeding a thread limit, etc. For example, the reinforcement learning agent is penalized for creating threads that are not required for the task. In another example, a large negative reward is applied when the reinforcement learning agent surpasses the allowed thread count.

In one embodiment, model trainer engine 203 scales the rewards (positive and negative) to avoid overwhelming the agent with large penalties or diminishing returns from small positive rewards.

In one embodiment, model trainer engine 203 continuously monitors the reinforcement learning agent's performance and adjusts the reward function parameters as needed to ensure alignment with the desired behavior and changing system conditions.

Model trainer engine 203 utilizes various software tools to design the reward function in a reinforcement learning environment as discussed above, including, but not limited to, Prometheus®, Datadog®, OpenAI® Gym, Ray®, etc.

Furthermore, in one embodiment, model trainer engine 203 formulates a thread scheduling strategy for the model based on positive and negative rewards. That is, model trainer engine 203 formulates a thread scheduling strategy using the principles of reinforcement learning, where actions that lead to desired outcomes (positive rewards) are encouraged, while actions leading to undesirable outcomes (negative rewards) are discouraged effectively guiding complex computing system 101 to optimize its thread scheduling decisions over time. A thread scheduling strategy, as used herein, refers to the strategy for determining the direction to tune threads for each thread type for each component of complex computing system 101 based on current environmental conditions.

In one embodiment, a reinforcement learning agent, such as a thread scheduler, learns by interacting with its environment (the system with threads to schedule) and receiving feedback in the form of rewards (positive or negative) for its actions. As previously discussed, a positive reward is given when the reinforcement learning agent, such as the thread scheduler, maximizes utilization of the threads within the allowed thread limit, improves overall system performance, etc. A negative reward is given when the reinforcement learning agent, such as the thread scheduler, selects a thread that leads to delays, resource bottlenecks, or other undesirable outcomes.

In one embodiment, the reinforcement learning agent, such as the thread scheduler, obtains the current state of complex computing system 101, including information, such as thread priorities, waiting times, resource availability, etc., from component manager 201 and thread manager 202.

In one embodiment, based on the current state, the reinforcement learning agent, such as the thread scheduler, chooses an action (increase, decrease or hold steady the number of threads for each thread type for a component of complex computing system 101) using a policy learned through reinforcement learning. After the action is taken, model trainer engine 203 provides a reward signal based on the outcome (e.g., providing a positive reward for maximizing utilization of the threads within the allowed thread limit).

In one embodiment, the reinforcement learning agent, such as the thread scheduler, uses this feedback to update its policy and gradually learns to prioritize actions that lead to more positive rewards and avoid actions that lead to negative rewards thereby optimizing its thread scheduling decisions over time. By learning from rewards, the reinforcement learning agent, such as the thread scheduler, appropriately predicts the direction to tune the threads for each thread type for each component of complex computing system 101. “Tuning the threads,” as used herein, refers to adjusting the number of threads for a thread type for a component of complex computing system 101, such as by increasing, decreasing, or holding steady the number of the threads for the thread type for the component of complex computing system 101.

In one embodiment, the formulated thread scheduling strategy of the model results in outputting the direction to tune the number of threads for each thread type for the component of complex computing system 101. For example, the thread scheduling strategy of the model may predict to increase, decrease or hold steady the number of threads for each thread type for a component of complex computing system 101. For instance, the data consistency comparison component of the active-active system includes three different types of threads, namely, the tPartioner thread type (partitions large data tables), the tCombiner thread type (performs data comparison) and the DiffReporter thread type (performs differential reporting). For example, the thread scheduling strategy of the model may predict to decrease the number of threads for the tPartioner thread type, increase the number of threads for the tCombiner thread type, and hold steady the number of threads for the DiffReporter thread type.

In one embodiment, the thread scheduling strategy of the model is then fine-tuned as discussed above.

As discussed above, thread manager 202 monitors the current environmental conditions, including memory usage, processor (CPU) usage, the state of the database tables and columns, the availability of resources, thread busy rate, etc. as discussed above.

The model then predicts the direction (e.g., increase, decrease, hold steady) to tune the threads for each thread type for a component of complex computing system 101.

Based on such a model prediction, thread manager 202 adjusts the number of threads for each thread type of the component.

Referring to the above example regarding the data consistency comparison component of the active-active system, if the model predicts to decrease the number of threads for the tPartioner thread type, increase the number of threads for the tCombiner thread type, and hold steady the number of threads for the DiffReporter thread type, then thread manager 202 adjusts the number of threads for each thread type of the component based on such a model prediction. For example, if the tPartitioner thread type currently has 20 threads, the tCombiner thread type currently has 15 threads, and the DiffReporter thread type currently has 17 threads, then thread manager 202 decreases the number of threads for the tPartitioner thread type from 20 to 18, increases the number of threads for the tCombiner thread type from 15 to 17 and holds steady the number of threads for the DiffReporter thread type at 17.

In one embodiment, thread manager 202 adjusts the number of threads for a thread type for a component of complex computing system 101 by modifying the settings within the application code or utilizing operating system-level configurations.

In one embodiment, thread manager 202 adjusts the number of threads for a thread type for a component of complex computing system 101 by accessing configuration parameters. For example, thread manager 202 adjusts the number of threads for a thread type for a component of complex computing system 101 by setting the number of threads using environment variables, such as OMP_NUM_THREADS. Other examples include directly modifying the number of threads for a thread type for a component of complex computing system 101 within the application code or through configuration files.

After such adjustment to the number of threads for each thread type of the component, model trainer engine 203 calculates the reward based on the current environmental conditions and the adjustment of the number of threads for a thread type for a component of complex computing system 101 (also referred to herein as the “component action”).

For example, thread manager 202 monitors the current environmental conditions, including memory usage, processor (CPU) usage, the state of the database tables and columns, the availability of resources, thread busy rate, etc. which is represented by the following formula:

E_{(i,j)}=(E_{(i,1)},E_{(i,2)},E_{(i,3)},E_{(i,4)},E_{(i,5)},E_{(i,6)}, . . . E_{(i,n)})

For every E_{(i,j)}, E is the environment element, such as memory usage, processor (CPU) usage, the state of the database tables and columns, the availability of resources, thread busy rate, etc., where i is the adjustment, and j is the number of every element.

Furthermore, as discussed above, thread manager 202 adjusts the number of threads for each thread type of the component based on the model prediction. Such an adjustment is referred to herein as the “component action” which is represented by the following formula for the thread types of tPartioner, tCombiner, and DiffReporter for the data consistency comparison component of the active-active system:

Aₙ=(tPartitioner↑,tPartitioner↓,tPartitioner−,tCombiner↑,tCombiner↓,tCombiner−,diffReporter↑,diffReporter↓,diffRep

[symbol]

where Aₙ refers to the action space, which includes the three possible tuning predictions by the model, such as increasing, decreasing, or holding steady the number of threads for a thread type for a component of complex computing system 101.

The action for each step is represented in the following step:

Aⱼ₍ᵢ₎=[Aⱼ₍ᵢ₎₍ₙ₎,Aⱼ₍ᵢ₎₍ₙ₋₁₎,Aⱼ₍ᵢ₎₍ₙ₋₂₎ . . . Aⱼ₍ᵢ₎₍ₙ₋ₘ₎]

The estimate for such action for each step is represented by the following formula:

ÂAⱼ₍ᵢ₎=[Âⱼ₍ᵢ₎₍ₙ₎,Âⱼ₍ᵢ₎₍ₙ₋₁₎,Âⱼ₍ᵢ₎₍ₙ₋₂₎ . . . Âⱼ₍ᵢ₎₍ₙ₋ₘ₎]

In one embodiment, model trainer engine 203 calculates the reward (R) based on the current environmental conditions E and the adjustment of the number of threads for a thread type for a component of complex computing system 101 (also referred to herein as the “component action (a)”) as shown in the following formula:

R(e,a)=R(e,a)+α(r+max_{a′}R(e′,a′)−R(e,a))

where α is a constant, e′ is the value of the environmental element in the previous iteration, and a′ is the value of the action in the previous iteration.

As a result, in one embodiment, model trainer engine 203 calculates the reward based on how well the current computing resources (e.g., memory usage) are being managed, such as by adjusting the number of threads assigned to a particular thread type for a component of complex computing system 101. Model trainer engine 203 rewards the agent (reinforcement learning agent) for making decisions (predicting directions to tune the threads for each thread type for the component of complex computing system 101) that optimize performance by efficiently utilizing available threads while considering current environment conditions (e.g., memory usage, thread busy rate, etc.). In this manner, the model is trained to effectively predict tuning direction of the threads based on the current environmental conditions and adjustments made to the number of threads for a thread type of a component of complex computing system 101.

Model trainer engine 203 determines if the average of the rewards over a set of episodes does not increase over a user-designated threshold. That is, model trainer engine 203 determines if the average reward over a set of episodes reaches a plateau or does not significantly increase beyond a user-designated threshold, which indicates that the reinforcement learning agent has largely optimized its policy and further training will not yield substantial performance improvements.

If the average of the rewards over a set of episodes increases over a user-designated threshold, then thread manager 202 monitors the current environmental conditions, including memory usage, processor (CPU) usage, the state of the database tables and columns, the availability of resources, thread busy rate, etc. as discussed above and the above-process is repeated.

If, however, the average of the rewards over a set of episodes does not increase over a user-designated threshold, then training of the model to predict the direction to tune the number of threads for each thread type for each component of complex computing system 101 based on environmental conditions (e.g., thread busy rate) is complete.

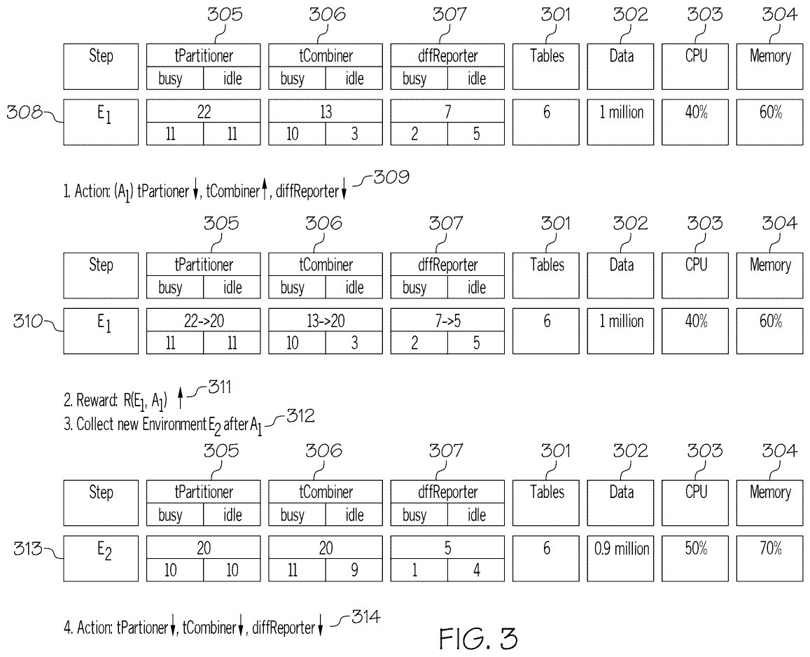

An example of fine-tuning the thread scheduling strategy as discussed above is illustrated in FIG. 3.

FIG. 3 illustrates fine-tuning the thread scheduling strategy in accordance with an embodiment of the present disclosure.

As shown in FIG. 3, the environmental conditions/elements (E) are monitored, such as the state of the database tables (tables) 301, the data utilization (data) 302, the processor (CPU) utilization (CPU) 303, and the memory utilization (memory) 304 for each thread type (e.g., tPartitioner 305, tCombiner 306, and diffReporter 307) for a component (e.g., data consistency comparison component in the active-active system) of complex computing system 101. In the first iteration or step (also referred to as an episode) for the environmental conditions/elements (E₁) 308, the number of threads for the tPartitioner thread type 305 is 22, where 11 of such threads are busy (i.e., actively executing) and 11 of such threads are idle. Furthermore, in the first iteration or step for the environmental conditions/elements (E₁) (see element 308), the number of threads for the tCombiner thread type 306 is 13, where 10 of such threads are busy (i.e., actively executing) and 3 of such threads are idle. Also, in the first iteration or step for the environmental conditions/elements (E₁) (see element 308), the number of threads for the diffReporter thread type 307 is 7, where 2 of such threads are busy (i.e., actively executing) and 5 of such threads are idle. Based on the monitored current environmental conditions of complex computing system 101 at the first iteration or step for the environmental conditions/elements (E₁) (see element 308), such as tables 301 corresponding to 6, data 302 corresponding to 1 millions, CPU 303 corresponding to 40%, and memory 304 corresponding to 60%, the trained model predicts the direction to tune the threads for each thread type (e.g., tPartitioner 305, tCombiner 306, and diffReporter 307) as shown in element 309. For example, the trained model predicts to decrease the number of threads for the tPartitioner thread type 305, increase the number of threads for the tCombiner thread type 306, and decrease the number of threads for the diffReporter thread type 307.

Accordingly, based on such a predicted direction, thread manager 202 adjusts the number of threads for each thread type (e.g., tPartitioner 305, tCombiner 306, and diffReporter 307) based on the model's predicted direction as shown in element 310. For example, thread manager 202 adjusts the number of threads for the tPartitioner thread type 305 by decreasing the number of threads from 22 to 20, adjusts the number of threads for the tCombiner thread type 306 by increasing the number of threads from 13 to 20, and adjusts the number of threads for the diffReporter thread type 307 by decreasing the number of threads from 7 to 5.

A reward is then calculated based on the monitored environmental conditions/elements (E₁) (see element 308) and the action (A₁) 309 performed as illustrated in element 311.

A determination is made as to whether the average of the rewards over a set of episodes does not increase over a user-designated threshold.

If the average of the rewards over a set of episodes increases over a user-designated threshold, then above-described process continues.

For example, thread manager 202 continues to monitor the current environmental conditions/elements (E₂) as shown in element 312. In such an example, at the second iteration or step, the current environmental conditions/elements (E₂) (see element 313), such as tables 301, data 302, CPU 303, and memory 304 correspond to 6, 0.9 million, 50%, and 70%, respectively. Furthermore, the current environmental conditions/elements (E₂) at the second iteration or step (see element 313) include the monitored thread busy rate for the tPartitioner thread type 305 which indicates that 10 threads are busy (i.e., actively executing) and 10 threads are idle, the monitored thread busy rate for the tCombiner thread type 306 which indicates that 11 threads are busy (i.e., actively executing) and 9 threads are idle, and the monitored thread busy rate for the diffReporter thread type 307 which indicates that 1 thread is busy (i.e., actively executing) and 4 threads are idle.

Based on the monitored current environmental conditions of complex computing system 101 at the second iteration or step for the environmental conditions/elements (E₂) (see element 313), the trained model predicts the direction to tune the threads for each thread type (e.g., tPartitioner 305, tCombiner 306, and diffReporter 307) as shown in element 314. For example, the trained model predicts to decrease the number of threads for the tPartitioner thread type 305, decrease the number of threads for the tCombiner thread type 306, and decrease the number of threads for the diffReporter thread type 307.

Thread manager 202 then proceeds to adjust the number of threads for each thread type (e.g., tPartitioner 305, tCombiner 306, and diffReporter 307) based on the model's predicted direction as previously discussed.

The above-described process continues until the average of the rewards over a set of episodes does not increase over a user-designated threshold.

After training the model to predict the direction to tune the number of threads for each thread type for each component of complex computing system 101 based on environmental conditions, including the thread busy rate, the model prediction is utilized to appropriately adjust the number of threads for a thread type for a component of complex computing system 101 based on the model prediction (predicted direction to tune the threads for each thread type for the component in complex computing system 101) as discussed below.

In one embodiment, after training the model to predict the direction to tune the threads for each thread type for each component of complex computing system 101 based on environmental conditions, including the thread busy rate, thread manager 202 monitors the current environmental conditions, including memory usage, processor (CPU) usage, the state of the database tables and columns, the availability of resources, thread busy rate, etc. as discussed above.

In one embodiment, thread manager 202 adjusts the number of threads for each thread type of a component in complex computing system 101 based on the direction to tune the threads for each thread type for the component in complex computing system 101 provided by the trained model based on the current environmental conditions of complex computing system 101. After adjusting the number of threads, thread manager 202 continues to monitor the current environmental conditions of complex computing system 101 and the above-described process is repeated.

In this manner, runtime bottlenecks are effectively handled in situations involving threads by adjusting the number of threads for each thread type for each component of a complex computing system based on the current environmental conditions, which may indicate the potential of a runtime bottleneck. Based on such thread adjustments, runtime bottlenecks are prevented from actually occurring by dynamically adjusting the number of threads to the available resources. For example, processing power may be maximized without overloading the CPU or memory. Furthermore, the complex computing system may maintain a smooth performance even when dealing with a fluctuating workload.

A further description of these and other features is provided below in connection with the discussion of the method for handling runtime bottlenecks.

Prior to the discussion of the method for handling runtime bottlenecks, a description of the hardware configuration of runtime bottleneck handler 102 (FIG. 1) is provided below in connection with FIG. 4.

Referring now to FIG. 4, in conjunction with FIG. 1, FIG. 4 illustrates an embodiment of the present disclosure of the hardware configuration of runtime bottleneck handler 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code (stored in block 401) involved in performing the inventive methods, such as handling runtime bottlenecks. In addition to block 401, computing environment 400 includes, for example, runtime bottleneck handler 102, network 103, such as a wide area network (WAN), end user device (EUD) 402, remote server 403, public cloud 404, and private cloud 405. In this embodiment, runtime bottleneck handler 102 includes processor set 406 (including processing circuitry 407 and cache 408), communication fabric 409, volatile memory 410, persistent storage 411 (including operating system 412 and block 401, as identified above), peripheral device set 413 (including user interface (UI) device set 414, storage 415, and Internet of Things (IoT) sensor set 416), and network module 417. Remote server 403 includes remote database 418. Public cloud 404 includes gateway 419, cloud orchestration module 420, host physical machine set 421, virtual machine set 422, and container set 423.

Runtime bottleneck handler 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 418. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically runtime bottleneck handler 102, to keep the presentation as simple as possible. Runtime bottleneck handler 102 may be located in a cloud, even though it is not shown in a cloud in FIG. 4. On the other hand, runtime bottleneck handler 102 is not required to be in a cloud except to any extent as may be affirmatively indicated.

Processor set 406 includes one, or more, computer processors of any type now known or to be developed in the future. Processing circuitry 407 may be distributed over multiple packages, for example, multiple, coordinated integrated circuit chips. Processing circuitry 407 may implement multiple processor threads and/or multiple processor cores. Cache 408 is memory that is located in the processor chip package(s) and is typically used for data or code that should be available for rapid access by the threads or cores running on processor set 406. Cache memories are typically organized into multiple levels depending upon relative proximity to the processing circuitry. Alternatively, some, or all, of the cache for the processor set may be located “off chip.” In some computing environments, processor set 406 may be designed for working with qubits and performing quantum computing.

Computer readable program instructions are typically loaded onto runtime bottleneck handler 102 to cause a series of operational steps to be performed by processor set 406 of runtime bottleneck handler 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 408 and the other storage media discussed below. The program instructions, and associated data, are accessed by processor set 406 to control and direct performance of the inventive methods. In computing environment 400, at least some of the instructions for performing the inventive methods may be stored in block 401 in persistent storage 411.

Communication fabric 409 is the signal conduction paths that allow the various components of runtime bottleneck handler 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 410 is any type of volatile memory now known or to be developed in the future. Examples include dynamic type random access memory (RAM) or static type RAM. Typically, the volatile memory is characterized by random access, but this is not required unless affirmatively indicated. In runtime bottleneck handler 102, the volatile memory 410 is located in a single package and is internal to runtime bottleneck handler 102, but, alternatively or additionally, the volatile memory may be distributed over multiple packages and/or located externally with respect to runtime bottleneck handler 102.

Persistent Storage 411 is any form of non-volatile storage for computers that is now known or to be developed in the future. The non-volatility of this storage means that the stored data is maintained regardless of whether power is being supplied to runtime bottleneck handler 102 and/or directly to persistent storage 411. Persistent storage 411 may be a read only memory (ROM), but typically at least a portion of the persistent storage allows writing of data, deletion of data and re-writing of data. Some familiar forms of persistent storage include magnetic disks and solid state storage devices. Operating system 412 may take several forms, such as various known proprietary operating systems or open source Portable Operating System Interface type operating systems that employ a kernel. The code included in block 401 typically includes at least some of the computer code involved in performing the inventive methods.

Peripheral device set 413 includes the set of peripheral devices of runtime bottleneck handler 102. Data communication connections between the peripheral devices and the other components of runtime bottleneck handler 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 414 may include components such as a display screen, speaker, microphone, wearable devices (such as goggles and smart watches), keyboard, mouse, printer, touchpad, game controllers, and haptic devices. Storage 415 is external storage, such as an external hard drive, or insertable storage, such as an SD card. Storage 415 may be persistent and/or volatile. In some embodiments, storage 415 may take the form of a quantum computing storage device for storing data in the form of qubits. In embodiments where runtime bottleneck handler 102 is required to have a large amount of storage (for example, where runtime bottleneck handler 102 locally stores and manages a large database) then this storage may be provided by peripheral storage devices designed for storing very large amounts of data, such as a storage area network (SAN) that is shared by multiple, geographically distributed computers. IoT sensor set 416 is made up of sensors that can be used in Internet of Things applications. For example, one sensor may be a thermometer and another sensor may be a motion detector.

Network module 417 is the collection of computer software, hardware, and firmware that allows runtime bottleneck handler 102 to communicate with other computers through WAN 103. Network module 417 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 417 are performed on the same physical hardware device. In other embodiments (for example, embodiments that utilize software-defined networking (SDN)), the control functions and the forwarding functions of network module 417 are performed on physically separate devices, such that the control functions manage several different network hardware devices. Computer readable program instructions for performing the inventive methods can typically be downloaded to runtime bottleneck handler 102 from an external computer or external storage device through a network adapter card or network interface included in network module 417.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 402 is any computer system that is used and controlled by an end user (for example, a customer of an enterprise that operates runtime bottleneck handler 102), and may take any of the forms discussed above in connection with runtime bottleneck handler 102. EUD 402 typically receives helpful and useful data from the operations of runtime bottleneck handler 102. For example, in a hypothetical case where runtime bottleneck handler 102 is designed to provide a recommendation to an end user, this recommendation would typically be communicated from network module 417 of runtime bottleneck handler 102 through WAN 103 to EUD 402. In this way, EUD 402 can display, or otherwise present, the recommendation to an end user. In some embodiments, EUD 402 may be a client device, such as thin client, heavy client, mainframe computer, desktop computer and so on.

Remote server 403 is any computer system that serves at least some data and/or functionality to runtime bottleneck handler 102. Remote server 403 may be controlled and used by the same entity that operates runtime bottleneck handler 102. Remote server 403 represents the machine(s) that collect and store helpful and useful data for use by other computers, such as runtime bottleneck handler 102. For example, in a hypothetical case where runtime bottleneck handler 102 is designed and programmed to provide a recommendation based on historical data, then this historical data may be provided to runtime bottleneck handler 102 from remote database 418 of remote server 403.

Public cloud 404 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 404 is performed by the computer hardware and/or software of cloud orchestration module 420. The computing resources provided by public cloud 404 are typically implemented by virtual computing environments that run on various computers making up the computers of host physical machine set 421, which is the universe of physical computers in and/or available to public cloud 404. The virtual computing environments (VCEs) typically take the form of virtual machines from virtual machine set 422 and/or containers from container set 423. It is understood that these VCEs may be stored as images and may be transferred among and between the various physical machine hosts, either as images or after instantiation of the VCE. Cloud orchestration module 420 manages the transfer and storage of images, deploys new instantiations of VCEs and manages active instantiations of VCE deployments. Gateway 419 is the collection of computer software, hardware, and firmware that allows public cloud 404 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 405 is similar to public cloud 404, except that the computing resources are only available for use by a single enterprise. While private cloud 405 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 404 and private cloud 405 are both part of a larger hybrid cloud.

Block 401 further includes the software components discussed above in connection with FIGS. 2-3 to handle runtime bottlenecks. In one embodiment, such components may be implemented in hardware. The functions discussed above performed by such components are not generic computer functions. As a result, runtime bottleneck handler 102 is a particular machine that is the result of implementing specific, non-generic computer functions.

In one embodiment, the functionality of such software components of runtime bottleneck handler 102, including the functionality for handling runtime bottlenecks, may be embodied in an application specific integrated circuit.

As stated above, in complex computing systems (e.g., z/OS online transaction system), multiple components and functions collaborate to provide services to users. These components may include different software modules and services. In such a system, such components both collaborate (work together) as well as compete for limited resources (e.g., processing power, memory) leading to an uneven distribution of those resources and creating runtime bottlenecks. A runtime bottleneck is a point within the computer program or system where a single component or process is unable to keep up with the demands placed on it thereby restricting the system's capacity to function efficiently. For example, in an active-active system, in order to keep data consistent (i.e., ensure that all copies of data across multiple servers remain identical and up-to-date), it is necessary to copy and compare data. An active-active system refers to a system architecture where multiple nodes or servers are simultaneously operational and actively processing requests. That is, in such a system, all nodes are actively contributing to the workload and can seamlessly take over if one fails thereby providing high availability and redundancy by distributing the load across all active components. In the active-active system, the component that is utilized to keep data consistent is the data consistency comparison component. Such a component includes three different types of threads, namely, the tPartioner thread type (partitions large data tables), the tCombiner thread type (performs data comparison) and the DiffReporter thread type (performs differential reporting). A thread is a single sequence of instructions within a program that can be executed independently allowing multiple tasks (task is a unit of work that needs to be completed) to seemingly run simultaneously within the same process effectively creating a form of multitasking within an application. Since each of these thread types are multithreaded (i.e., each type of thread is capable of running multiple threads within itself allowing for concurrent execution of different parts of a task simultaneously), it is possible that one of the threads will become the bottleneck in the compare process performed by the data consistency comparison component. That is, even though the system is using multiple threads to run tasks concurrently, there is a chance that one particular thread within the system could become the slowest part and hold up the entire process due to excessive workload or inefficient code within that specific thread thereby creating a bottleneck. Unfortunately, there is not currently a means for effectively handling runtime bottlenecks, including in situations involving threads.

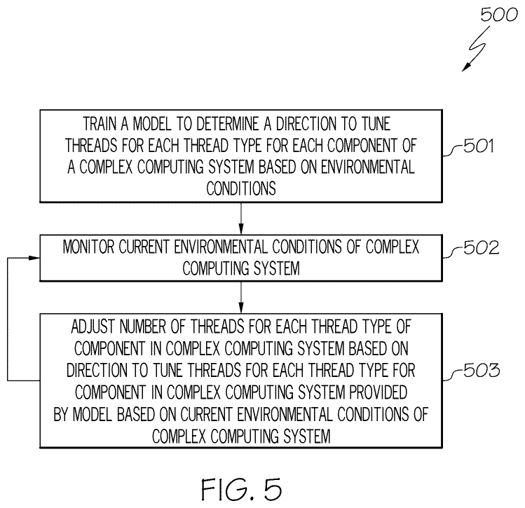

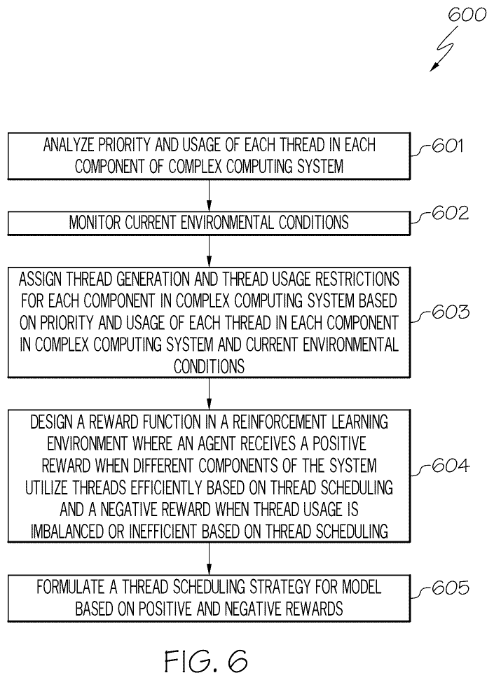

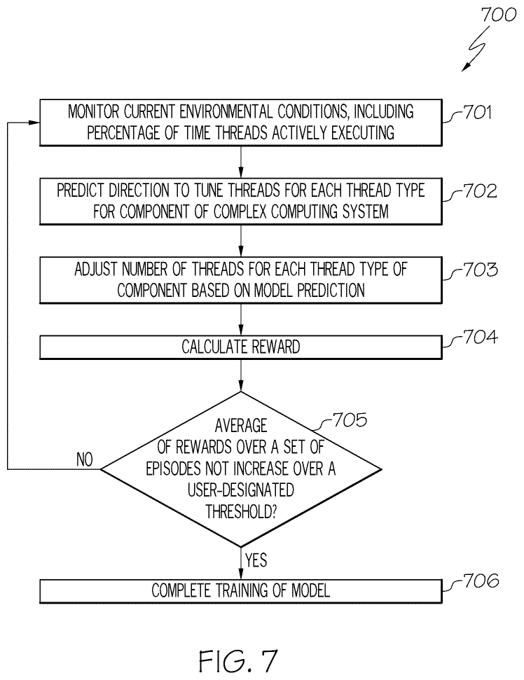

The embodiments of the present disclosure provide a means for effectively handling runtime bottlenecks by automatically adjusting the number of threads for each thread type for the components of the complex computing system as discussed below in connection with FIGS. 5-7. FIG. 5 is a flowchart of a method for handling runtime bottlenecks. FIG. 6 is a flowchart of a method for formulating a thread scheduling strategy. FIG. 7 is a flowchart of a method for fine-tuning the thread scheduling strategy.

As stated above, FIG. 5 is a flowchart of a method 500 for handling runtime bottlenecks in accordance with an embodiment of the present disclosure.

Referring to FIG. 5, in conjunction with FIGS. 1-4, in step 501, model trainer engine 203 trains a model, such as via reinforcement learning, to determine a direction to tune threads for each thread type for each component of complex computing system 101 based on environmental conditions, such as the percentage of time the threads are actively executing (“thread busy rate”).

In connection with such training, a thread scheduling strategy is formulated as discussed below in connection with FIG. 6.

FIG. 6 is a flowchart of a method 600 for formulating a thread scheduling strategy in accordance with an embodiment of the present disclosure.

Referring to FIG. 6, in conjunction with FIGS. 1-5, in step 601, component manager 201 analyzes the priority and usage of each thread in each component in complex computing system 101.

As stated above, in one embodiment, component manager 201 analyzes the priority and usage of each thread within complex computing system 101 by utilizing a combination of system monitoring tools, profiling techniques, and application-specific logging to gather detailed information about thread execution times, processor usage, priority levels, and potential bottlenecks thereby enabling the identification of which threads are most activity utilized and if their assigned priorities align with their criticality within complex computing system 101.

In one embodiment, the system monitoring tools utilized by component manger 201 include operating system tools, such as the task manager, which includes detailed thread information, such as processor usage, priority levels, and the scheduling state. That is, such operating system tools provide a comprehensive view of running processes and their threads, including the processing usage and priority levels within the process hierarchy.

In one embodiment, the performance monitoring tools utilized by component manger 201 gather detailed performance metrics, such as cache misses, branch predictions, and context switches on a per-thread basis. Examples of such performance monitoring tools include perf and ptrace.

In one embodiment, the application-specific monitoring performed by component manager 201 includes logging, which captures the thread start/stop times, key events, and potential bottlenecks and correlating this information with system-level monitoring data. Furthermore, in one embodiment, component manager 201 utilizes application-specific metrics to track thread activity, such as queue lengths, wait times, and resource usage within the components.

In one embodiment, the profiling tools utilized by component manger 201 include sampling profiles (e.g., Profiler, gprof) that periodically sample the execution stack to identify which functions and threads are consuming the most processor time. Furthermore, in one embodiment, the profiling tools utilized by component manger 201 include instrumentation profilers, which insert code snippets in the application to measure specific function calls and thread activity.

In one embodiment, component manager 201 compares the assigned priority of threads with their processor usage to determine if high-priority threads are getting the adequate processor (CPU) time.

In one embodiment, component manager 201 analyzes the thread wait times. For example, component manager 201 investigates the threads that are frequently blocked on synchronization primitives or input/output operations, which could indicate potential concurrency issues.

In one embodiment, component manager 201 identifies which components are most impacted by thread contention or inefficiently scheduled based on performance data.

In step 602, thread manager 202 monitors the current environmental conditions, including the percentage of time the threads are actively executing (“thread busy rate”). Current environmental conditions, as used herein, refer to the conditions of the elements of complex computing system 101 that directly impact its performance at the present time, such as memory usage, processor (CPU) usage, the state of the database tables and columns, the availability of resources, thread busy rate, etc.

As discussed above, in one embodiment, thread manager 202 keeps track of the current performance of complex computing system 101 by specifically observing how much time its individual “threads” (small units of processing within a program) are actively working on tasks. An actively working thread, as used herein, refers to a thread that is performing work on the processor (CPU) and not waiting for input or paused.

In one embodiment, by thread manager 202 tracking the percentage of time threads are actively executing, thread manager 202 gauges how much processing power is being used by complex computing system 101 system at any given time.

Furthermore, in one embodiment, thread manager 202 performs performance analysis. For example, a high percentage of actively executing threads suggests that complex computing system 101 is under heavy load and may be experiencing performance issues. In another example, if specific applications or processes consistently have high thread activity, it could indicate that they are the primary cause of performance slowdown.

Additionally, in one embodiment, thread manager 202 monitors current environmental conditions, including thread activity, via a task manager, which allows thread manger 202 to obtain processor (CPU) usage and individual thread activity for each running process.

Furthermore, in one embodiment, thread manager 202 utilizes system monitoring tools to obtain detailed information about thread activity, including the percentage of time spent actively executing. Examples of such system monitoring tools include, but are not limited to, Datadog®, New Relic®, Dynatrace®, ManageEngine®, etc.

In step 603, thread manager 202 assigns thread generation and thread usage restrictions for each component in complex computing system 101 based on the priority and usage of each thread in each component in complex computing system 101 and the current environmental conditions.

That is, thread manager 202 determines how many threads each component of complex computing system 101 can create (thread generation) and how actively those threads should be used taking into account the priority of each thread within that component, how much each thread is currently being used, and the overall system conditions, such as memory usage, processor (CPU) usage, current thread activity (thread busy rate), etc.

As stated above, different threads within a component may have different levels of importance. As a result, in one embodiment, thread manager 202 prioritizes creating and utilizing higher priority threads prior to lower priority threads.

In one embodiment, thread usage restrictions involves setting limits on the number of threads a component can create at once, or throttling how often a particular thread is allowed to run, to prevent excessive resource consumption.

Thread manager 202 utilizes various software tools for assigning thread generation and thread usage restrictions for each component in complex computing system 101 including, but not limited to, Pthreads, FixedThreadPool, CachedThreadPool, ScheduledThreadPoolExecutor, etc.

In step 604, model trainer engine 203 designs a reward function in a reinforcement learning environment where an agent receives a positive reward when different components of complex computing system 101 utilize threads efficiently based on thread scheduling and a negative reward when thread usage is imbalanced or inefficient based on thread scheduling.

As discussed above, thread scheduling, as used herein, refers to determining which thread should execute next thereby managing the order of execution among multiple threads where different thread types may have varying priorities depending on their function or importance within complex computing system 101.

In one embodiment, model trainer engine 203 incentivizes a reinforcement learning agent to utilize threads effectively by rewarding actions that optimize thread utilization within the constraints (e.g., thread generation and usage restrictions) and penalizing excessive thread creation or unnecessary thread usage that violates the restrictions.

In one embodiment, the elements of the reward function include the thread utilization metric, constraint violation penalty and positive/negative reinforcement.

In one embodiment, the thread utilization metric includes the thread wait time in which the reinforcement learning agent is penalized for creating threads that spend a significant time waiting for resources. In one embodiment, the thread utilization metric includes active thread count, where the reinforcement learning agent is rewarded for maintaining a balance number of active threads and maximizing utilization within the allowed thread limit.

In one embodiment, the constraint violation penalty includes applying a negative reward if the reinforcement learning agent creates more threads than the allowed limit. Furthermore, the constraint violation penalty includes applying a negative reward for excessive processor (CPU) or memory usage related to thread creation and management.

In one embodiment, model trainer engine 203 implements positive reinforcement, such as an incremental reward for efficient thread usage, a larger reward for optimal thread utilization, etc. For example, model trainer engine 203 awards small positive rewards for each decision that effectively utilizes threads within the constraints (e.g., creating a thread only when needed, recycling threads from a pool, etc.). In another example, model trainer engine 203 provides a larger reward when the reinforcement learning agent achieves near-optimal thread utilization while respecting limits.

In one embodiment, model trainer engine 203 implements negative reinforcement, such as a penalty for unnecessary thread creation, a penalty for exceeding a thread limit, etc. For example, the reinforcement learning agent is penalized for creating threads that are not required for the task. In another example, a large negative reward is applied when the reinforcement learning agent surpasses the allowed thread count.

In one embodiment, model trainer engine 203 scales the rewards (positive and negative) to avoid overwhelming the agent with large penalties or diminishing returns from small positive rewards.

In one embodiment, model trainer engine 203 continuously monitors the reinforcement learning agent's performance and adjusts the reward function parameters as needed to ensure alignment with the desired behavior and changing system conditions.

Model trainer engine 203 utilizes various software tools to design the reward function in a reinforcement learning environment as discussed above, including, but not limited to, Prometheus®, Datadog®, OpenAI® Gym, Ray®, etc.

In step 605, model trainer engine 203 formulates a thread scheduling strategy for the model based on positive and negative rewards. That is, model trainer engine 203 formulates a thread scheduling strategy using the principles of reinforcement learning, where actions that lead to desired outcomes (positive rewards) are encouraged, while actions leading to undesirable outcomes (negative rewards) are discouraged effectively guiding complex computing system 101 to optimize its thread scheduling decisions over time. A thread scheduling strategy, as used herein, refers to the strategy for determining the direction to tune threads for each thread type for each component of complex computing system 101 based on current environmental conditions.

As discussed above, in one embodiment, a reinforcement learning agent, such as a thread scheduler, learns by interacting with its environment (the system with threads to schedule) and receiving feedback in the form of rewards (positive or negative) for its actions. As previously discussed, a positive reward is given when the reinforcement learning agent, such as the thread scheduler, maximizes utilization of the threads within the allowed thread limit, improves overall system performance, etc. A negative reward is given when the reinforcement learning agent, such as the thread scheduler, selects a thread that leads to delays, resource bottlenecks, or other undesirable outcomes.

In one embodiment, the reinforcement learning agent, such as the thread scheduler, obtains the current state of complex computing system 101, including information, such as thread priorities, waiting times, resource availability, etc., from component manager 201 and thread manager 202.

In one embodiment, based on the current state, the reinforcement learning agent, such as the thread scheduler, chooses an action (increase, decrease or hold steady the number of threads for each thread type for a component of complex computing system 101) using a policy learned through reinforcement learning. After the action is taken, model trainer engine 203 provides a reward signal based on the outcome (e.g., providing a positive reward for maximizing utilization of the threads within the allowed thread limit).

In one embodiment, the reinforcement learning agent, such as the thread scheduler, uses this feedback to update its policy and gradually learns to prioritize actions that lead to more positive rewards and avoid actions that lead to negative rewards thereby optimizing its thread scheduling decisions over time. By learning from rewards, the reinforcement learning agent, such as the thread scheduler, appropriately predicts the direction to tune the threads for each thread type for each component of complex computing system 101. “Tuning the threads,” as used herein, refers to adjusting the number of threads for a thread type for a component of complex computing system 101, such as by increasing, decreasing, or holding steady the number of the threads for the thread type for the component of complex computing system 101.

In one embodiment, the formulated thread scheduling strategy of the model results in outputting the direction to tune the number of threads for each thread type for the component of complex computing system 101. For example, the thread scheduling strategy of the model may predict to increase, decrease or hold steady the number of threads for each thread type for a component of complex computing system 101. For instance, the data consistency comparison component of the active-active system includes three different types of threads, namely, the tPartioner thread type (partitions large data tables), the tCombiner thread type (performs data comparison) and the DiffReporter thread type (performs differential reporting). For example, the thread scheduling strategy of the model may predict to decrease the number of threads for the tPartioner thread type, increase the number of threads for the tCombiner thread type, and hold steady the number of threads for the DiffReporter thread type.

In one embodiment, the thread scheduling strategy of the model is then fine-tuned as discussed below in connection with FIG. 7.

FIG. 7 is a flowchart of a method 700 for fine-tuning the thread scheduling strategy in accordance with an embodiment of the present disclosure.

Referring to FIG. 7, in conjunction with FIGS. 1-6, in step 701, thread manager 202 monitors the current environmental conditions, including memory usage, processor (CPU) usage, the state of the database tables and columns, the availability of resources, thread busy rate (percentage of time threads actively executing), etc. as discussed above.

In step 702, the model predicts the direction (e.g., increase, decrease, hold steady) to tune the threads for each thread type for a component of complex computing system 101 based on the current environmental conditions.

Based on such a model prediction, in step 703, thread manager 202 adjusts the number of threads for each thread type of the component.

As stated above, referring to the above example regarding the data consistency comparison component of the active-active system, if the model predicts to decrease the number of threads for the tPartioner thread type, increase the number of threads for the tCombiner thread type, and hold steady the number of threads for the DiffReporter thread type, then thread manager 202 adjusts the number of threads for each thread type of the component based on such a model prediction. For example, if the tPartioner thread type currently has 20 threads, the tCombiner thread type currently has 15 threads, and the DiffReporter thread type currently has 17 threads, then thread manager 202 decreases the number of threads for the tPartioner thread type from 20 to 18, increases the number of threads for the tCombiner thread type from 15 to 17 and holds steady the number of threads for the DiffReporter thread type at 17.

In one embodiment, thread manager 202 adjusts the number of threads for a thread type for a component of complex computing system 101 by modifying the settings within the application code or utilizing operating system-level configurations.

In one embodiment, thread manager 202 adjusts the number of threads for a thread type for a component of complex computing system 101 by accessing configuration parameters. For example, thread manager 202 adjusts the number of threads for a thread type for a component of complex computing system 101 by setting the number of threads using environment variables, such as OMP_NUM_THREADS. Other examples include directly modifying the number of threads for a thread type for a component of complex computing system 101 within the application code or through configuration files.

After such adjustment to the number of threads for each thread type of the component, in step 704, model trainer engine 203 calculates the reward based on the current environmental conditions and the adjustment of the number of threads for a thread type for a component of complex computing system 101 (also referred to herein as the “component action”).

As discussed above, for example, thread manager 202 monitors the current environmental conditions, including memory usage, processor (CPU) usage, the state of the database tables and columns, the availability of resources, thread busy rate, etc. which is represented by the following formula:

E_{(i,j)}=(E_{(i,1)},E_{(i,2)},E_{(i,3)},E_{(i,4)},E_{(i,5)},E_{(i,6)}, . . . E_{(i,n)})

For every E_{(i,j)}, E is the environment element, such as memory usage, processor (CPU) usage, the state of the database tables and columns, the availability of resources, thread busy rate, etc., where i is the adjustment, and j is the number of every element.

Furthermore, as discussed above, thread manager 202 adjusts the number of threads for each thread type of the component based on the model prediction. Such an adjustment is referred to herein as the “component action” which is represented by the following formula for the thread types of tPartioner, tCombiner, and DiffReporter for the data consistency comparison component of the active-active system:

Aₙ=(tPartitioner↑,tPartitioner↓,tPartitioner−,tCombiner↑,tCombiner↓,tCombiner−,diffReporter↑,diffReporter↓,diffRep

[symbol]

where Aₙ refers to the action space, which includes the three possible tuning predictions by the model, such as increasing, decreasing, or holding steady the number of threads for a thread type for a component of complex computing system 101.

The action for each step is represented in the following step:

Aⱼ₍ᵢ₎=[Aⱼ₍ᵢ₎₍ₙ₎,Aⱼ₍ᵢ₎₍ₙ₋₁₎,Aⱼ₍ᵢ₎₍ₙ₋₂₎ . . . Aⱼ₍ᵢ₎₍ₙ₋ₘ₎]

The estimate for such action for each step is represented by the following formula:

ÂAⱼ₍ᵢ₎=[Âⱼ₍ᵢ₎₍ₙ₎,Âⱼ₍ᵢ₎₍ₙ₋₁₎,Âⱼ₍ᵢ₎₍ₙ₋₂₎ . . . Âⱼ₍ᵢ₎₍ₙ₋ₘ₎]

In one embodiment, model trainer engine 203 calculates the reward (R) based on the current environmental conditions E and the adjustment of the number of threads for a thread type for a component of complex computing system 101 (also referred to herein as the “component action (a)”) as shown in the following formula:

R(e,a)=R(e,a)+α(r+max_{a′}R(e′,a′)−R(e,a))

where α is a constant, e′ is the value of the environmental element in the previous iteration, and a′ is the value of the action in the previous iteration.

As a result, in one embodiment, model trainer engine 203 calculates the reward based on how well the current computing resources (e.g., memory usage) are being managed, such as by adjusting the number of threads assigned to a particular thread type for a component of complex computing system 101. Model trainer engine 203 rewards the agent (reinforcement learning agent) for making decisions (predicting directions to tune the threads for each thread type for the component of complex computing system 101) that optimize performance by efficiently utilizing available threads while considering current environment conditions (e.g., memory usage, thread busy rate, etc.). In this manner, the model is trained to effectively predict tuning direction of the threads based on the current environmental conditions and adjustments made to the number of threads for a thread type of a component of complex computing system 101.

In step 705, model trainer engine 203 determines if the average of the rewards over a set of episodes does not increase over a user-designated threshold. That is, model trainer engine 203 determines if the average reward over a set of episodes reaches a plateau or does not significantly increase beyond a user-designated threshold, which indicates that the reinforcement learning agent has largely optimized its policy and further training will not yield substantial performance improvements.

If the average of the rewards over a set of episodes increases over a user-designated threshold, then thread manager 202 monitors the current environmental conditions, including memory usage, processor (CPU) usage, the state of the database tables and columns, the availability of resources, thread busy rate, etc. in step 701 and the above-process is repeated.

If, however, the average of the rewards over a set of episodes does not increase over a user-designated threshold, then, in step 706, model trainer engine 203 completes the training of the model to predict the direction to tune the number of threads for each thread type for each component of complex computing system 101 based on environmental conditions (e.g., thread busy rate).

An example of fine-tuning the thread scheduling strategy as discussed above is illustrated in FIG. 3.

As shown in FIG. 3, the environmental conditions/elements (E) are monitored, such as the state of the database tables (tables) 301, the data utilization (data) 302, the processor (CPU) utilization (CPU) 303, and the memory utilization (memory) 304 for each thread type (e.g., tPartitioner 305, tCombiner 306, and diffReporter 307) for a component (e.g., data consistency comparison component in the active-active system) of complex computing system 101. In the first iteration or step (also referred to as an episode) for the environmental conditions/elements (E₁) 308, the number of threads for the tPartitioner thread type 305 is 22, where 11 of such threads are busy (i.e., actively executing) and 11 of such threads are idle. Furthermore, in the first iteration or step for the environmental conditions/elements (E₁) (see element 308), the number of threads for the tCombiner thread type 306 is 13, where 10 of such threads are busy (i.e., actively executing) and 3 of such threads are idle. Also, in the first iteration or step for the environmental conditions/elements (E₁) (see element 308), the number of threads for the diffReporter thread type 307 is 7, where 2 of such threads are busy (i.e., actively executing) and 5 of such threads are idle. Based on the monitored current environmental conditions of complex computing system 101 at the first iteration or step for the environmental conditions/elements (E₁) (see element 308), such as tables 301 corresponding to 6, data 302 corresponding to 1 millions, CPU 303 corresponding to 40%, and memory 304 corresponding to 60%, the trained model predicts the direction to tune the threads for each thread type (e.g., tPartitioner 305, tCombiner 306, and diffReporter 307) as shown in element 309. For example, the trained model predicts to decrease the number of threads for the tPartitioner thread type 305, increase the number of threads for the tCombiner thread type 306, and decrease the number of threads for the diffReporter thread type 307.

Accordingly, based on such a predicted direction, thread manager 202 adjusts the number of threads for each thread type (e.g., tPartitioner 305, tCombiner 306, and diffReporter 307) based on the model's predicted direction as shown in element 310. For example, thread manager 202 adjusts the number of threads for the tPartitioner thread type 305 by decreasing the number of threads from 22 to 20, adjusts the number of threads for the tCombiner thread type 306 by increasing the number of threads from 13 to 20, and adjusts the number of threads for the diffReporter thread type 307 by decreasing the number of threads from 7 to 5.

A reward is then calculated based on the monitored environmental conditions/elements (E₁) (see element 308) and the action (A₁) 309 performed as illustrated in element 311.

A determination is made as to whether the average of the rewards over a set of episodes does not increase over a user-designated threshold.

If the average of the rewards over a set of episodes increases over a user-designated threshold, then above-described process continues.

For example, thread manager 202 continues to monitor the current environmental conditions/elements (E₂) as shown in element 312. In such an example, at the second iteration or step, the current environmental conditions/elements (E₂) (see element 313), such as tables 301, data 302, CPU 303, and memory 304 correspond to 6, 0.9 million, 50%, and 70%, respectively. Furthermore, the current environmental conditions/elements (E₂) at the second iteration or step (see element 313) include the monitored thread busy rate for the tPartitioner thread type 305 which indicates that 10 threads are busy (i.e., actively executing) and 10 threads are idle, the monitored thread busy rate for the tCombiner thread type 306 which indicates that 11 threads are busy (i.e., actively executing) and 9 threads are idle, and the monitored thread busy rate for the diffReporter thread type 307 which indicates that 1 thread is busy (i.e., actively executing) and 4 threads are idle.

Based on the monitored current environmental conditions of complex computing system 101 at the second iteration or step for the environmental conditions/elements (E₂) (see element 313), the trained model predicts the direction to tune the threads for each thread type (e.g., tPartitioner 305, tCombiner 306, and diffReporter 307) as shown in element 314. For example, the trained model predicts to decrease the number of threads for the tPartitioner thread type 305, decrease the number of threads for the tCombiner thread type 306, and decrease the number of threads for the diffReporter thread type 307.

Thread manager 202 then proceeds to adjust the number of threads for each thread type (e.g., tPartitioner 305, tCombiner 306, and diffReporter 307) based on the model's predicted direction as previously discussed.

The above-described process continues until the average of the rewards over a set of episodes does not increase over a user-designated threshold.

After training the model to predict the direction to tune the threads for each thread type for each component of complex computing system 101 based on environmental conditions, including the thread busy rate, the model prediction is utilized to appropriately adjust the number of threads for a thread type for a component of complex computing system 101 based on the model prediction (predicted direction to tune the number of threads for each thread type for the component in the complex computing system) as discussed below.

Returning to FIG. 5, in conjunction with FIGS. 1-4 and 6-7, in step 502, after training the model to predict the direction to tune the number of threads for each thread type for each component of complex computing system 101 based on environmental conditions, including the thread busy rate, thread manager 202 monitors the current environmental conditions of complex computing system 101, including memory usage, processor (CPU) usage, the state of the database tables and columns, the availability of resources, thread busy rate, etc. as discussed above.

In step 503, thread manager 202 adjusts the number of threads for each thread type of a component in complex computing system 101 based on the direction to tune the threads for each thread type for the component in complex computing system 101 provided by the trained model based on the current environmental conditions of complex computing system 101. After adjusting the number of threads, thread manager 202 continues to monitor the current environmental conditions of complex computing system 101 and the above-described process (steps 502-503) is repeated.

In this manner, runtime bottlenecks are effectively handled by adjusting the number of threads for each thread type for each component of a complex computing system based on the current environmental conditions, which may indicate the potential of a runtime bottleneck. Based on such thread adjustments, runtime bottlenecks are prevented from actually occurring by dynamically adjusting the number of threads to the available resources. For example, processing power may be maximized without overloading the CPU or memory. Furthermore, the complex computing system may maintain a smooth performance even when dealing with a fluctuating workload.

Furthermore, the principles of the present disclosure improve the technology or technical field involving complex computing systems.

As discussed above, in complex computing systems (e.g., z/OS online transaction system), multiple components and functions collaborate to provide services to users. These components may include different software modules and services. In such a system, such components both collaborate (work together) as well as compete for limited resources (e.g., processing power, memory) leading to an uneven distribution of those resources and creating runtime bottlenecks. A runtime bottleneck is a point within the computer program or system where a single component or process is unable to keep up with the demands placed on it thereby restricting the system's capacity to function efficiently. For example, in an active-active system, in order to keep data consistent (i.e., ensure that all copies of data across multiple servers remain identical and up-to-date), it is necessary to copy and compare data. An active-active system refers to a system architecture where multiple nodes or servers are simultaneously operational and actively processing requests. That is, in such a system, all nodes are actively contributing to the workload and can seamlessly take over if one fails thereby providing high availability and redundancy by distributing the load across all active components. In the active-active system, the component that is utilized to keep data consistent is the data consistency comparison component. Such a component includes three different types of threads, namely, the tPartioner thread type (partitions large data tables), the tCombiner thread type (performs data comparison) and the DiffReporter thread type (performs differential reporting). A thread is a single sequence of instructions within a program that can be executed independently allowing multiple tasks (task is a unit of work that needs to be completed) to seemingly run simultaneously within the same process effectively creating a form of multitasking within an application. Since each of these thread types are multithreaded (i.e., each type of thread is capable of running multiple threads within itself allowing for concurrent execution of different parts of a task simultaneously), it is possible that one of the threads will become the bottleneck in the compare process performed by the data consistency comparison component. That is, even though the system is using multiple threads to run tasks concurrently, there is a chance that one particular thread within the system could become the slowest part and hold up the entire process due to excessive workload or inefficient code within that specific thread thereby creating a bottleneck. Unfortunately, there is not currently a means for effectively handling runtime bottlenecks, including in situations involving threads.

Embodiments of the present disclosure improve such technology by training a model to determine a direction to tune threads for each thread type for each component of a complex computing system based on environmental conditions. Environmental conditions, as used herein, refer to the conditions of the elements of the complex computing system that directly impact its performance, such as memory usage, processor (CPU) usage, the state of the database tables and columns, the availability of resources, thread busy rate, etc. Furthermore, current environmental conditions of the complex computing system are monitored. The number of threads for each thread type for a component of the complex computing system is then adjusted based on the direction to tune the threads for each thread type for the component in the system provided by the model, which is based on the current environmental conditions of the system. In this manner, runtime bottlenecks are effectively handled in situations involving threads using thread adjustments. Based on such thread adjustments, runtime bottlenecks are prevented from actually occurring by dynamically adjusting the number of threads to the available resources. For example, processing power may be maximized without overloading the CPU or memory. Furthermore, the complex computing system may maintain a smooth performance even when dealing with a fluctuating workload. Furthermore, in this manner, there is an improvement in the technical field involving complex computing systems.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for handling runtime bottlenecks, the method comprising:
training a model to determine a direction to tune threads for each thread type for each component of a system based on environmental conditions;
monitoring current environmental conditions of said system; and
adjusting a number of threads for each thread type for a component in said system based on a direction to tune said threads for each thread type for said component in said system provided by said model based on said current environmental conditions of said system.

2. The method as recited in claim 1 further comprising:
analyzing priority and usage of each thread in each component in said system.

3. The method as recited in claim 2 further comprising:
assigning thread generation and thread usage restrictions for each component in said system based on said current environmental conditions and said priority and usage of each thread in each component of said system.

4. The method as recited in claim 3 further comprising:
designing a reward function in a reinforcement learning environment where an agent receives a positive reward when different components of said system utilize threads efficiently based on thread scheduling and a negative reward when thread usage is imbalanced or inefficient based on said thread scheduling.

5. The method as recited in claim 4 further comprising:
formulating a thread scheduling strategy for said model based on said positive rewards and said negative rewards.

6. The method as recited in claim 5, wherein said thread scheduling strategy is fine-tuned by:
calculating a reward based on said current environmental conditions of said system and said adjustment of said number of threads for each thread type for said component of said system.

7. The method as recited in claim 1 further comprising:
monitoring said current environmental conditions of said system after adjusting said number of threads for each thread type for said component in said system a first time; and
adjusting said number of threads for each thread type for said component in said system a second time based on a direction to tune said threads for each thread type for said component in said system provided by said model a second time based on said current environmental conditions of said system monitored after adjusting said number of threads for each thread type for said component in said system said first time.

8. A computer program product for handling runtime bottlenecks, the computer program product comprising one or more computer readable storage mediums having program code embodied therewith, the program code comprising programming instructions for:
training a model to determine a direction to tune threads for each thread type for each component of a system based on environmental conditions;
monitoring current environmental conditions of said system; and
adjusting a number of threads for each thread type for a component in said system based on a direction to tune said threads for each thread type for said component in said system provided by said model based on said current environmental conditions of said system.

9. The computer program product as recited in claim 8, wherein the program code further comprises the programming instructions for:
analyzing priority and usage of each thread in each component in said system.

10. The computer program product as recited in claim 9, wherein the program code further comprises the programming instructions for:
assigning thread generation and thread usage restrictions for each component in said system based on said current environmental conditions and said priority and usage of each thread in each component of said system.

11. The computer program product as recited in claim 10, wherein the program code further comprises the programming instructions for:
designing a reward function in a reinforcement learning environment where an agent receives a positive reward when different components of said system utilize threads efficiently based on thread scheduling and a negative reward when thread usage is imbalanced or inefficient based on said thread scheduling.

12. The computer program product as recited in claim 11, wherein the program code further comprises the programming instructions for:
formulating a thread scheduling strategy for said model based on said positive rewards and said negative rewards.

13. The computer program product as recited in claim 12, wherein said thread scheduling strategy is fine-tuned by:
calculating a reward based on said current environmental conditions of said system and said adjustment of said number of threads for each thread type for said component of said system.

14. The computer program product as recited in claim 8, wherein the program code further comprises the programming instructions for:
monitoring said current environmental conditions of said system after adjusting said number of threads for each thread type for said component in said system a first time; and
adjusting said number of threads for each thread type for said component in said system a second time based on a direction to tune said threads for each thread type for said component in said system provided by said model a second time based on said current environmental conditions of said system monitored after adjusting said number of threads for each thread type for said component in said system said first time.

15. A system, comprising:
a memory for storing a computer program for handling runtime bottlenecks; and
a processor connected to said memory, wherein said processor is configured to execute program instructions of the computer program comprising:
training a model to determine a direction to tune threads for each thread type for each component of a system based on environmental conditions;
monitoring current environmental conditions of said system; and
adjusting a number of threads for each thread type for a component in said system based on a direction to tune said threads for each thread type for said component in said system provided by said model based on said current environmental conditions of said system.

16. The system as recited in claim 15, wherein the program instructions of the computer program further comprise:
analyzing priority and usage of each thread in each component in said system.

17. The system as recited in claim 16, wherein the program instructions of the computer program further comprise:
assigning thread generation and thread usage restrictions for each component in said system based on said current environmental conditions and said priority and usage of each thread in each component of said system.

18. The system as recited in claim 17, wherein the program instructions of the computer program further comprise:
designing a reward function in a reinforcement learning environment where an agent receives a positive reward when different components of said system utilize threads efficiently based on thread scheduling and a negative reward when thread usage is imbalanced or inefficient based on said thread scheduling.

19. The system as recited in claim 18, wherein the program instructions of the computer program further comprise:
formulating a thread scheduling strategy for said model based on said positive rewards and said negative rewards.

20. The system as recited in claim 19, wherein said thread scheduling strategy is fine-tuned by:
calculating a reward based on said current environmental conditions of said system and said adjustment of said number of threads for each thread type for said component of said system.
